(19) United States
(12) Patent Application Publication
(10) Pub. No.: US 2002/0049675 A1
(43) Pub. Date: Apr. 25, 2002

(54) System and user interface for managing users and services over a wireless communications network

(76) Inventors: Kari Kailamaki, Espoo (FI); Sanjay Khurana, Oakton, VA (US); Matti Suomalainen, Espoo (FI)

Correspondence Address: LOTT & FRIEDLAND, P.A., P.O. BOX 141098, CORAL GABLES, FL, 33114-1098, US

(21) Appl. No.: 09/860,342

(22) Filed: May 18, 2001

Related U.S. Application Data
(60) Provisional application No. 60/203,810, filed on May 19, 2000.

(51) Int. Cl. G06F 17/60

(52) U.S. Cl. 705/44

(57) ABSTRACT

The present invention is a system for managing users and services over a Wireless Application Protocol (WAP) Gateway. The system provides a way to create and maintain user and group accounts and a method of authenticating user identities for the purpose of assigning an access level and granting the use of services. The system also provides for: assigning service subscriptions to a specific user or group; setting parameters on the length of time a specific user or group has access to services; defining payers and payment methods for each service subscription that a user or a group has; defining user and group aliases for customized identification; importing or exporting user and group information in a usable format; a user interface capable of implementing all the features of the system; and cooperating with data storage equipment and data storage and processing software required for the management of users and services.

CLAIM OF PRIORITY

This application is related to provisional application Ser. No. 60/203,810 filed on May 19, 2000 based upon which priority is claimed pursuant to 35 U.S.C. § 119(e).

### TECHNICAL FIELD

This invention relates generally to a computer-based method and system for managing users and services of a Wireless Application Protocol (WAP) Gateway. More specifically, user management involves creating and maintaining user accounts including user subscriptions. Individual users can then be aggregated for group management. Group management entails creating groups of users and subscribing these groups to certain services. System management involves entering and removing service information into and from the system and making services available to users of the system.

### BACKGROUND OF THE INVENTION

The demand for wireless services is growing rapidly all around the world. Businesspeople and ordinary consumers lead increasingly mobile lives; they are no longer bound to their home and office computers, but still want to have information at their fingertips whenever they need it. Wireless networks provide people on the move with a medium for easy information access.

The Wireless Application Protocol (WAP) is the de facto world standard for displaying and transmitting information and telephony services on mobile phones and other wireless terminals. The global WAP specification was developed by the industry's top experts as an open standard to implement wireless Internet access. This open standard benefits the whole wireless telecommunication community: carriers, infrastructure vendors, application developers, service providers, and, ultimately, end users. The WAP specification extends existing mobile networking and Internet technologies. It is bearer and device independent, and thus helps foster interoperability.

The WAP programming model is largely based on the WWW programming model with clients and servers. Existing standards have been used as a starting point for WAP technology whenever possible. They have been optimized and extended to provide the best functionality in a wireless environment.

The basic WAP model consists of a client (a WAE user agent, also called a WAP terminal), a Gateway, and an origin or content server. A request is sent by an end user through a WAP terminal to a content server on the Internet or in a network. The WAP terminal transmits the request, a standard HTTP request in encoded format, to the Gateway. The Gateway decodes and processes the request and sends it on to the appropriate content server. The response from the content server is sent back to the Gateway over HTTP. The Gateway encodes the response and transmits it to the WAP terminal.

The WAP model defines a set of standard components for communication between WAP terminals and content servers.

Standard URL names are used to identify WAP content in a network.

Content is identified by a specific type consistent with WWW typing in order to enable correct processing in the WAP terminal.

Standard content formats based on WWW technology are used.

Standard communications protocols are used to transmit requests from WAP terminals to content servers.

The client device in the WAP programming model is a WAP terminal: a mobile phone or other wireless device used by the end user to request and receive information. A microbrowser in the WAP terminal controls the user interface analogously to a standard Web browser. WAP terminals typically accept data in WML and WMLScript formats. Different types of terminals may also accept bitmaps and other content types.

A WAP Gateway communicates with content servers by using the standard HTTP 1.1 protocol. The Gateway's location between the WAP terminal and the content server can be compared to that of a standard WWW proxy server. However, a Gateway differs from a proxy in that it receives requests from end users as if it were the actual content server for the requested data. The Gateway is usually transparent to the end user. The Gateway functionality can be added to content servers or placed in a dedicated Gateway machine, as in FIG. 1.

The Gateway performs most tasks related to WAP use, which minimizes the demand for processing power in the WAP terminal. The use of a Gateway allows content and applications to be hosted on standard WWW servers and developed with WWW technologies.

The Gateway translates requests from the WAP protocol stack to WWW protocols. It also provides functionality for encoding and decoding data transferred from and to the WAP terminal. WML content from the Internet needs to be encoded in order to minimize the size and number of packets sent to the WAP terminal.

Servers in the WAP model are standard WWW servers that provide WAP content. Content servers can be located on the Internet or in a local network. The content can be anything: stock quotes, weather reports, news headlines, banking services . . . There are no restrictions to the format of data provided by content servers, but the capabilities of the receiving WAP terminal determines which formats are accepted.

The WAP architecture provides a scalable and extensible environment for further development of applications and devices. The WAP specification defines a lightweight protocol stack that can operate on high-latency, low-bandwidth wireless networks. The stack is located in the Gateway and designed so that a variety of networks can run WAP applications. The WAP architecture consists of various layers. External services and applications can use the features provided by different layers through a set of defined interfaces.

WAE is a general application environment based on a combination of WWW and mobile telephony technologies. It provides an interoperable environment for building applications and services that can function in a variety of wireless networks. WAE includes a microbrowser environment for use in WAP terminals.

The session layer is based on modified binary-encoded HTTP 1.1. It provides the application layer with a consistent interface for two modes of session services: connection-oriented and connectionless.

The connection-oriented mode operates above the WTP layer. It provides acknowledgements for request-reply transactions and more reliable service, but uses more bandwidth and processing power in WAP terminals. Connectionless mode operates above WDP. It does not provide acknowledgements, but enables the use of WAP even in narrowband networks and WAP terminals with limited processing power.

Most connections between the WAP terminal and the Gateway use WSP regardless of the protocol of the content server from which data is requested. The URL used to request data specifies the protocol used by the content server. Thus, the end user does not need to know what protocol is used in intervening connections.

The transaction layer provides a lightweight, transaction-oriented protocol suitable for implementation in wireless networks. WTP can be compared to traditional TCP in terms of function. However, WTP reduces the amount of information that needs to be transmitted for each request-response transaction, and is thus optimized for wireless use. WTP provides reliability in connections by way of acknowledgements and retransmissions.

The WTLS security protocol is based on the industry standard TLS protocol. WTLS has been optimized for use over narrow-band communication channels and provides features such as data integrity, privacy, authentication, and denial-of-service protection. Most WAP terminals can enable or disable WTLS features depending on the security requirements and the underlying network. The security layer is thus optional in the WAP architecture, but may be used for services such as banking and e-commerce.

The transport layer protocol operates transparently above the bearer services and is adapted to specific features of the underlying bearer. The transport layer provides a common interface for the upper layer protocols (security, transaction, session, and application), which are thus able to function independently of the bearer network.

WAP is designed to operate over different bearer networks. The network layer in the protocol stack supports these bearers. Different bearers offer different levels of service, which the WAP protocols are designed to compensate.

The WAP specification includes the Wireless Markup Language (WML). WML is a tag-based document language that conforms to XML standards and is designed especially for use within the limited computing environment of mobile terminal devices.

From the WAP Gateway, all WML content on Web servers is accessed with standard HTTP 1.1 requests. WML documents are divided into units of user interaction called cards and decks. A deck is defined as the entire WML document retrieved (e.g. “Today's news stories”), and a card is the amount of data displayed at once on the WAP terminal (e.g. “First story”, “Second story”). Using cards and decks makes browsing the content faster, as the data does not have to be retrieved from the content server every time the user needs it. The WAP content can be browsed analogously to Web pages: the user can navigate back and forth between cards from one or several decks.

WML provides a variety of features, such as the following:

Content authors can specify text and images presented to the end user.

Layout and presentation on WAP terminals are specified in general terms, which allows independence for device developers.

Support is provided for elements to solicit user input, such as text entries (e.g. passwords) and option selection.

WML allows several navigation mechanisms using URLs and enables international support for different character sets.

WML includes a variety of technologies to optimize communication on narrow-band devices.

WML enables state and context management.

WMLScript is a lightweight, procedural scripting language. It is loosely based on a subset of the industry standard JavaScript™ language, but adapted for optimum use in the narrow-band environment of wireless terminals. WMLScript supports several basic data types and attempts to convert automatically between different types when necessary. WMLScript also supports several categories of operations and functions and defines several standard libraries.

WMLScript is fully integrated with the WML browser in the WAP terminal and enhances the standard browsing and presentation facilities of WML. It enables the WAP terminal to interact with the user in a more intelligent way, for example to check the validity of user input before it is sent to the content server.

Due to the limited processing power of WAP terminals and the requirements of over-the-air transmission, data needs to be sent from the Gateway to the WAP terminal in as compact a format as possible. The Gateway contains compilers that convert WML and WMLScript into their binary encoded counterparts. Each WML deck is converted into its binary format, WMLC; WMLScript is compiled into low-level bytecode. The compiled data is then sent to the WAP terminal for interpretation and execution.

Many applications on the Internet, such as banking services, require a secure connection between the WAP terminal and the content server. The WAP specification defines a security layer, WTLS, which is used with WAP transport protocols. WAP can provide end-to-end security for connections where the terminal and content server communicate directly using WAP protocols.

The WAP environment supports HTTP 1.1 basic authentication where an end user can be authenticated on the basis of a username and a password. WAP can also use the authentication methods of the underlying bearer network. Authentication and security clearance enables a user to receive a predetermined set of system services, but because WAP technology is in its infancy, there are few, if any, solutions for managing users and services over a WAP Gateway.

Therefore, there is a need in the art for a system for managing users and services over a WAP Gateway.

There is a further need in the art for a way to create and maintain user and group accounts.

There is a further need in the art for a method of authenticating user identities for the purpose of assigning an access level and granting the use of services.

There is a further need in the art for a system for managing users and services over a WAP Gateway for assigning service subscriptions to a specific user or group.

There is a further need in the art for a system for managing users and services over a WAP Gateway for setting parameters on the length of time a specific user or group has access to services.

There is a further need in the art for a system for managing users and services over a WAP Gateway that can define payers and payment methods for each service subscription that a user or a group has.

There is a further need in the art for a system for managing users and services over a WAP Gateway that can define user and group aliases for customized identification.

There is a further need in the art for a system for managing users and services over a WAP Gateway that can import or export user and group information in a usable format.

There is a further need in the art for a system for managing users and services over a WAP Gateway that provides a user interface capable of implementing all the features of the system.

There is a further need in the art for a system for managing users and services over a WAP Gateway that is capable of cooperating with data storage equipment and data storage and processing software required for the management of users and services.

### SUMMARY OF THE INVENTION

User management in the Knowledge Base involves creating and maintaining user accounts. Group management entails creating groups of users and subscribing these groups to certain services.

In a preferred embodiment of the invention, what is provided is a method for managing users and services in a system for providing information over a Wireless Application Protocol Gateway, comprising creating a service provider entry for a company that provides a service; adding the service as available to users; creating a user account for a specific user on a database; and, creating a subscription to at least one available service for the user.

In an alternative embodiment of the invention, what is provided is a user interface for administration and management of users and services in a Wireless Application Protocol Gateway on a graphical display surface, comprising a series of screens, modifyable by a system, that allow the administrator to create and maintain user and group accounts, authenticate user identities for the purpose of assigning an access level and granting the use of services, assign service subscriptions to a specific user or group, set parameters on the length of time a specific user or group has access to services, define payers and payment methods for each service subscription that a user or a group has, define user and group aliases for customized identification, import or export user and group information in a usable format.

It is an object of this invention to provide a system for managing users and services over a WAP Gateway.

It is a further object of this invention to provide a way to create and maintain user and group accounts.

It is a further object of this invention to provide a method of authenticating user identities for the purpose of assigning an access level and granting the use of services.

It is a further object of this invention to provide a system for managing users and services over a WAP Gateway for assigning service subscriptions to a specific user or group.

It is a further object of this invention to provide a system for managing users and services over a WAP Gateway for setting parameters on the length of time a specific user or group has access to services.

It is a further object of this invention to provide a system for managing users and services over a WAP Gateway that can define payers and payment methods for each service subscription that a user or a group has.

It is a further object of this invention to provide a system for managing users and services over a WAP Gateway that can define user and group aliases for customized identification.

It is a further object of this invention to provide a system for managing users and services over a WAP Gateway that can import or export user and group information in a usable format.

It is a further object of this invention to provide a system for managing users and services over a WAP Gateway that provides a user interface capable of implementing all the features of the system.

It is a further object of this invention to provide a system for managing users and services over a WAP Gateway that is capable of cooperating with data storage equipment and data storage and processing software required for the management of users and services.

### BRIEF DESCRIPTION OF THE DRAWINGS

FIG. 1 A schematic view of the WAP Gateway system architecture.

FIG. 2 A detailed schematic view of the WAP Gateway system architecture.

FIG. 3 A graphic representation of the New Bearer Address page.

FIG. 4 A graphic representation of the Users page.

FIG. 5 A graphic representation of the Administration Console.

FIG. 6 A schematic view of the Administration Console.

FIG. 7 A continued schematic view representation of the Administration Console.

FIG. 8 A graphic representation of the Subscriptions page.

FIG. 9 A graphic representation of the New Subscription page.

FIG. 10 A graphic representation of the Subscription Edit page.

FIG. 11 A graphic representation of the Subscription Billing Parameters page.

FIG. 12 A graphic representation of the New Subscription Billing Parameters page.

FIG. 13 A graphic representation of the User Alias page.

FIG. 14 A graphic representation of the New User page.

FIG. 15 A graphic representation of the New User Group page.

FIG. 16 A graphic representation of the User Groups page.

FIG. 17 A graphic representation of the User Groups Edit page.

FIG. 18 A graphic representation of the Group's Members page.

### DETAILED DESCRIPTION OF THE PREFERRED EMBODIMENT OF THE PRESENT INVENTION

When a user uses a WAP terminal to request a service, the terminal connects to the WAP Gateway. The bearer address (MSISDN, telephone number, or IP address) of the terminal where the incoming call originated is matched against a set of user identifiers. The caller's user information, which is stored in the optional Knowledge Base, is retrieved and the caller is granted or refused access to the service being requested on this basis. If for any reason the bearer address entry that matches the bearer address of the incoming call's originator cannot be located in the Knowledge Base, the user is logged on as an anonymous user.

An individual user's service subscriptions are either specific to the user account or defined through the user's group memberships. Groups can be thought of as one type of user. However, while individual users can belong to one or more groups, a group cannot belong to another group. If a service subscription is defined through a group membership, then users who belong to a group that subscribes to a particular service have access to that service.

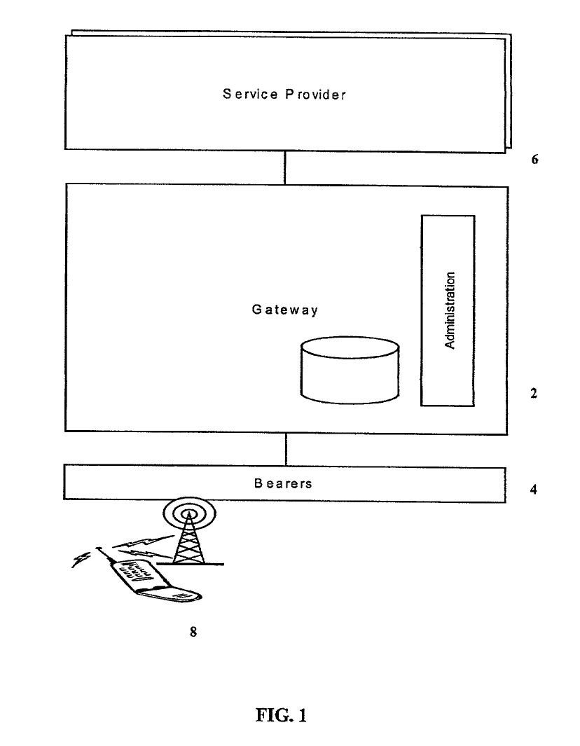

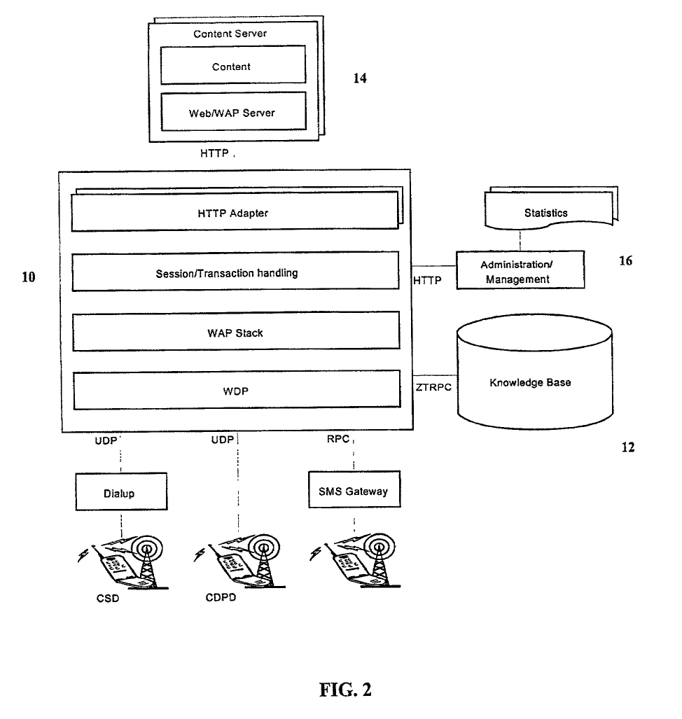

Turning to FIG. 1 and FIG. 2, user 8 management in the Knowledge Base 12 involves creating and maintaining user 8 accounts. Group management entails creating groups of users 8 and subscribing these groups to certain services. Users 8 and groups are basically managed in the same way. The differences are firstly that users 8 can be members of groups, and secondly that groups can be either ordinary groups or organizations. User 8, group and service management concerns the Knowledge Base 12 module of the WAP Gateway 2. This module 12 is optional and is not included in every installation.

When a user 8 uses a WAP terminal to request a service, the terminal connects to the WAP Gateway 2. The bearer address (MSISDN, telephone number, or IP address) of the terminal where the incoming call originated is matched against a set of user 8 identifiers. The caller's user 8 information, which is stored in the Knowledge Base 12, is retrieved and the caller is granted or refused access to the service being requested on this basis.

If for any reason the bearer address entry that matches the bearer address of the incoming call's originator cannot be located in the Knowledge Base 12, the user 8 is logged on as an anonymous user 8.

An individual user's 8 service subscriptions are either specific to the user 8 account or defined through the user's 8 group memberships. Groups can be thought of as one type of user 8. However, while individual users 8 can belong to one or more groups, a group cannot belong to another group. If a service subscription is defined through a group membership, then users 8 who belong to a group that subscribes to a particular service have access to that service.

There are two ways of allowing a user 8 access to a given service through the Gateway 2, depending on whether the user 8 is subscribed individually or as a member of a group. The steps required for each are listed below:

Individual subscriptions

1 Create a service provider 6 entry for the company that provides the service.

2 Add the service.

3 Create a user 8 account for the user 8.

4 In the user 8 account, create a subscription to the service.

Group subscriptions

1 Create a service provider 6 entry for the company that provides the service.

2 Add the service.

3 Create the group.

4 Subscribe the group to the service.

5 Create a user 8 account for the user 8.

6 Add the user 8 to the group.

The order of the above steps is the recommended one, but it can vary a little. The only requirements are that service providers 6 must exist in the Knowledge Base 12 before their services; services must exist before they can be subscribed to; subscribers must exist before they can subscribe to services; and groups must exist before users 8 can be added to them.

When creating new users 8, the only piece of information about the user 8 that is absolutely required for access to WAP services is the bearer network address (see below). However, more information is required for personalized access and billing. The following information can be provided:

User's 8 name

User's 8 identifier

Bearer network address (user's 8 telephone number or the number for another type of WAP terminal (MSISDN, CDPD))

Authentication permission

Service subscriptions

Group memberships

(User 8 aliases)

To distinguish users 8, each user 8 entry must be associated with a unique identifier. The user's 8 bearer network address (telephone number, MSISDN or IP address) is used for authenticating incoming calls and associated with the user's 8 identifier, which is then used for retrieving the caller's group memberships. To make this possible, authentication must be explicitly allowed for the specified bearer address. Service subscriptions control access to services available through the Gateway 2. The user's 8 group memberships are used for retrieving some settings associated with the user 8. User-level aliases can include the user's 8 personal homepage, for example.

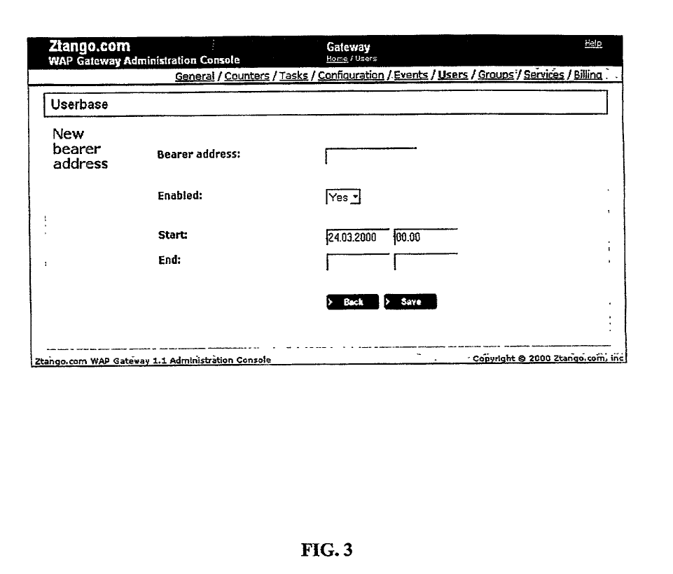

To define new bearer addresses for user 8, enter the user's 8 or group's bearer address on the New Bearer Address page FIG. 3. To enable authentication for this number, select Yes in the Enabled dropdown box. In the Start text boxes, enter the date and time when the number becomes valid. In the End text boxes, enter the date and time when the number ceases to be valid. Click Save. Click “Ok”.

The Unique identifier may be derived from an external system and/or entered manually. The Gateway 2 system can also generate unique identifiers. To generate a unique identifier in the Gateway 2, leave the identifier field blank when you enter information. The system 2 automatically assigns an ID for the entry. The user 8 ID cannot be edited once it has been entered. The only way to assign a new user 8 ID to a user 8 is to open a new account. The unique identifier can include up to 16 characters. Include only the following types of characters:

a-z

A-Z

0-9

The Bearer network address (MSISDN, telephone number, IP-address) refers to the address that identifies the connecting WAP device.

The bearer network address is stored for authentication purposes. When the user 8 calls in, i.e. the user 8 sends a request for a service, the Gateway 2 searches for a match for the originating bearer address from the addresses stored in the Knowledge Base 12. When a match is found, the Gateway 2 assigns the user 8 ID associated with the address in the Knowledge Base 12 to the caller.

If the bearer address is a GSM telephone number or other MSISDN number, the device is then assigned a temporary IP address for the duration of the connection. If the connection is a GSM data call, the GSM number has to be resolved to the user's 8 MSISDN for authentication. If the device has a permanent IP address, then that IP address is used.

Thus in order to use the WAP Gateway 2 to connect to services, each individual user 8 must have a bearer address that is associated with a user 8 ID. A user 8 can also have many addresses, each of which returns the same user 8 ID upon authentication query.

The period that the bearer address is valid has an adjustable time limit, meaning that you can specify the time period during which the user 8 has access to services.

Telephone numbers are entered as international telephone numbers in the format +nnnnnnnnnnnnnn. The telephone number may include up to 14 digits and the plus (+) sign. Do not use spaces. IP addresses are entered in the usual format n.n.n.n.

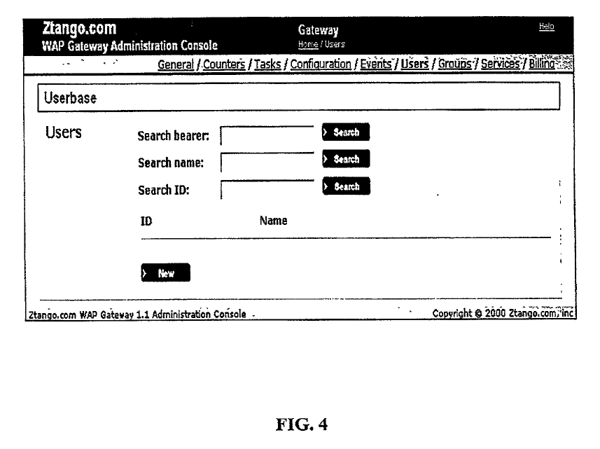

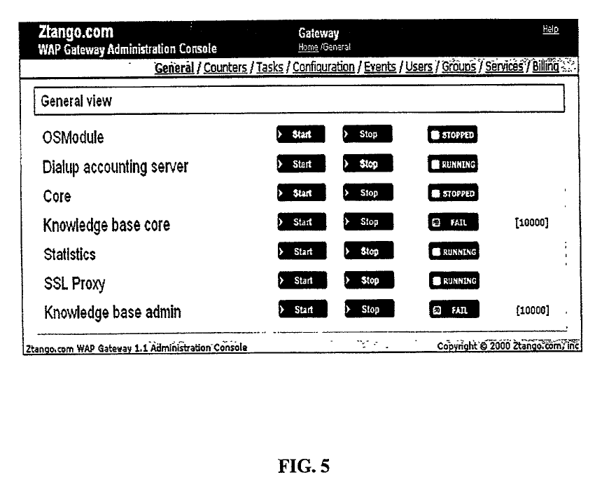

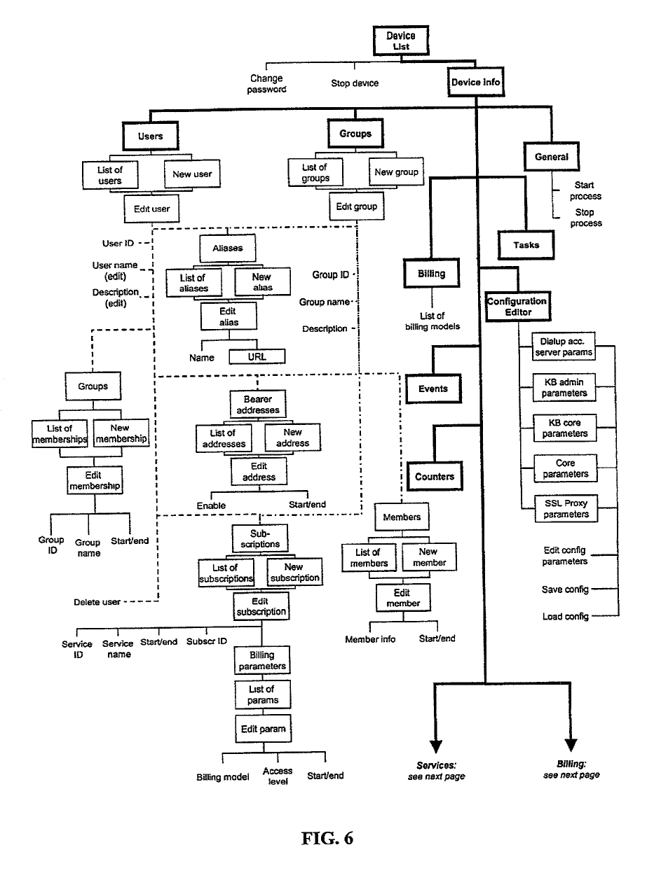

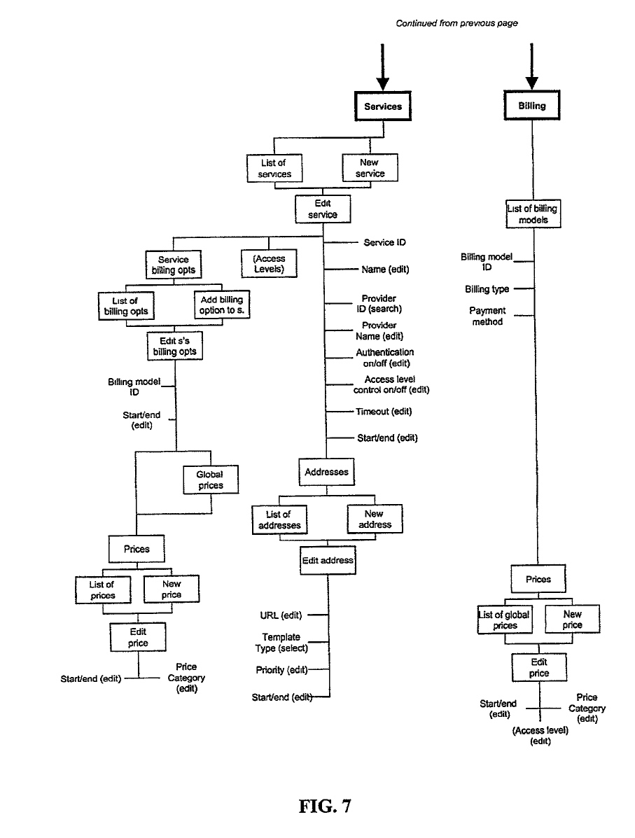

The default setting is to allow authentication for all callers' bearer network addresses. If authentication is not allowed, the setting prevents authentication from taking place when a particular WAP terminal connects to the Gateway 2. This can be useful if you want to disable the user's 8 access to advanced services, but wish to keep the user 8 in the Knowledge Base 12. You can prevent authentication on the Users page FIG. 4 of the Administration Console FIG. 5, for a schematic of the Administration Console see FIGS. 6 and 7.

Some settings are specified for entire groups at a time; e.g. some of the users' 8 access rights for various services. In other words, some service subscriptions are specific to groups and not users 8, and in order to access a service the user 8 must belong to a group that is subscribed to that service. Other settings include billing parameters and group-level aliases.

Users 8 can subscribe to services individually or through groups. They can access only those services that they subscribe to, regardless of whether the service is invoiceable or free access. You can specify various options for each subscription.

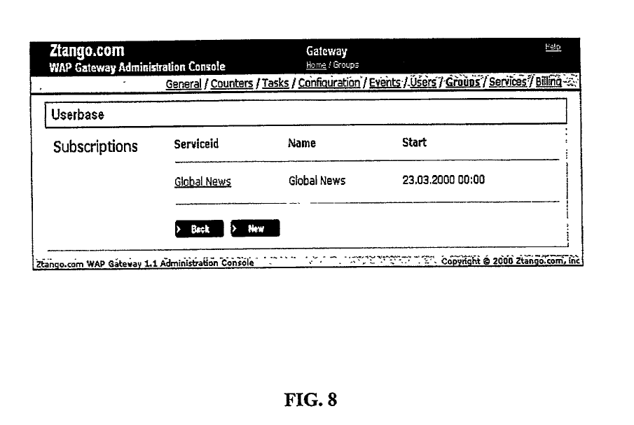

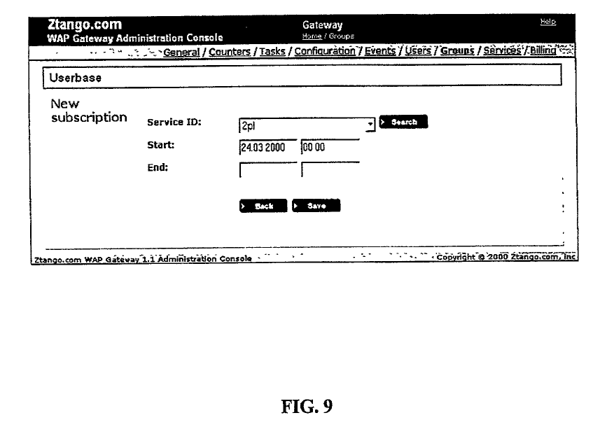

To subscribe a user 8 or a group to a service, find the user 8 or group in the Knowledge Base 12. Click the “Subscriptions” link. The user's 8 or group's Subscriptions page FIG. 8 opens. Click “New”. The New subscription page FIG. 9 opens. On the Service ID drop-down list, find the service you want to subscribe the user 8 or group to. In the Start text box, enter first the date and then the time when the subscription becomes valid. In the End text box, enter first the date and then the time when the subscription ceases to be valid. Click “Save.” Click “Ok.”

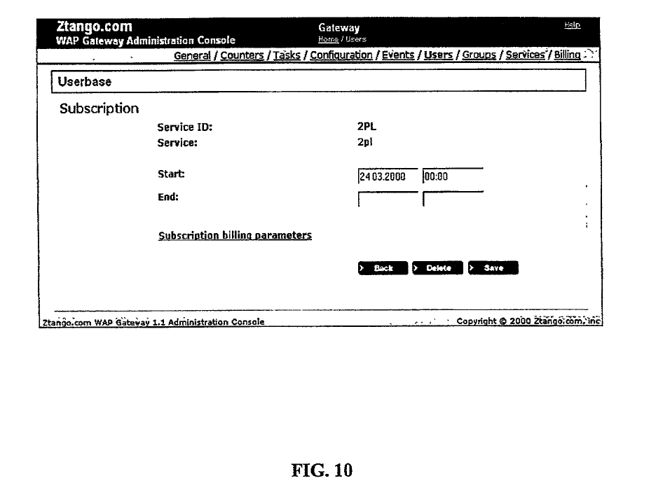

To view and edit an existing subscription Find the user 8 or group in the Knowledge Base 12. Click the “Subscriptions” link. The Subscriptions page FIG. 8 opens, displaying a list of subscriptions. In the list of subscriptions, click the subscription you want to view or modify. The subscription's edit page FIG. 10 opens.

By default, the payer is the user 8 who uses the service. You can also define another payer. For example, the user's 8 employer may wish to provide a given service for its employees, or a company can offer a limited time membership as a bonus for its customers.

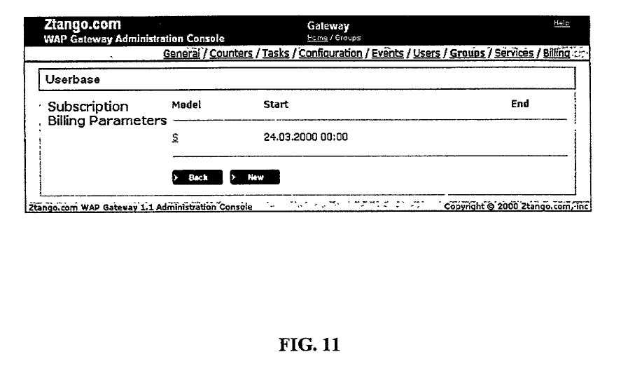

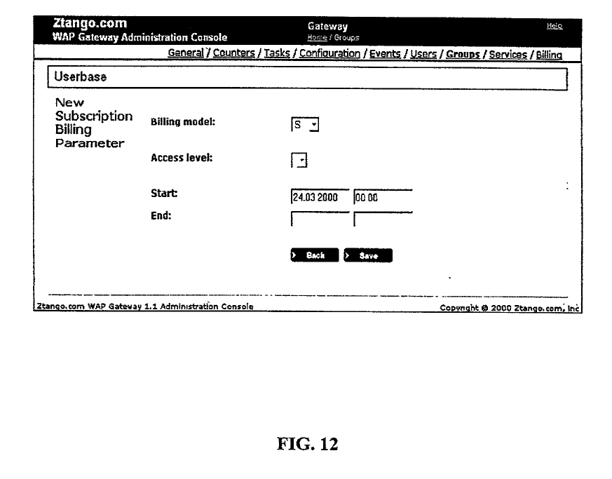

You can define payers and payment methods for each service subscription that a user 8 or a group has. These options must be defined so that only one set is valid at a time. To set a subscription's billing options Find the user 8 or group in the Knowledge Base 12. Navigate to the subscription you want to modify. Click the “Subscription billing parameters” link. The user's 8 Subscription Billing Parameters page FIG. 11 opens. Click “New”. The New Subscription Parameter page FIG. 12 opens. In the Billing model drop-down box, select the billing model you want to apply to the subscription. If access level control has been enabled for the service in question, select an access level for the user 8 or group. In the Start text boxes, enter the date and the time when the billing parameter becomes valid. In the End text boxes, enter the date and the time when the billing parameter ceases to be valid. Click “Save”. Click “Ok”.

The billing models where the payment method is phonebill allow you to define a payer who is different from the user 8 (or group) who actually subscribes to the service. The payer must be a user 8 with a user 8 account in the Knowledge Base 12. To define a payer Find the user 8 or group in the Knowledge Base 12. Navigate to the subscription you want to modify. Create a new subscription billing parameter, selecting a billing model with phonebill defined as the payment method. Click “Save”. Click “Ok”. The Edit Subscription Billing Parameter page FIG. 10 opens. In the Payer ID text box, enter the ID of the user 8 you want to define as payer or Click “Browse” to locate the payer in the Knowledge Base 12. Click “Save”. Click “Ok”.

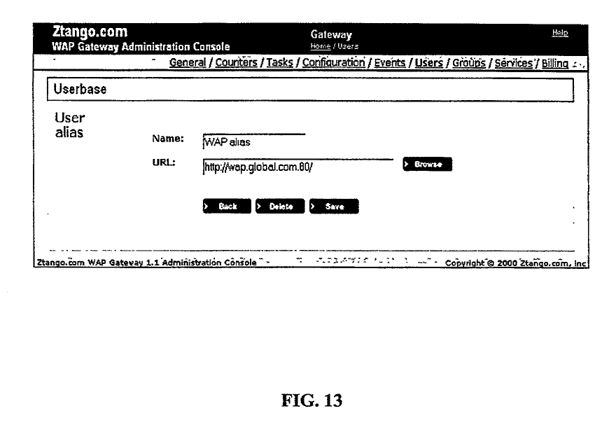

Some aliases are defined individually for each user 8, for instance the users' 8 homepages. You can find the link to the Aliases page FIG. 13 on the user's User page of the Administration console, FIG. 5.

You can add any user 8 to any group. First you must have a group that the user 8 can be added to. Groups are created by the Service administrator 16. When you have created a group, add users 8 to it. Users 8 can be added only to existing groups. Groups cannot be members of other groups.

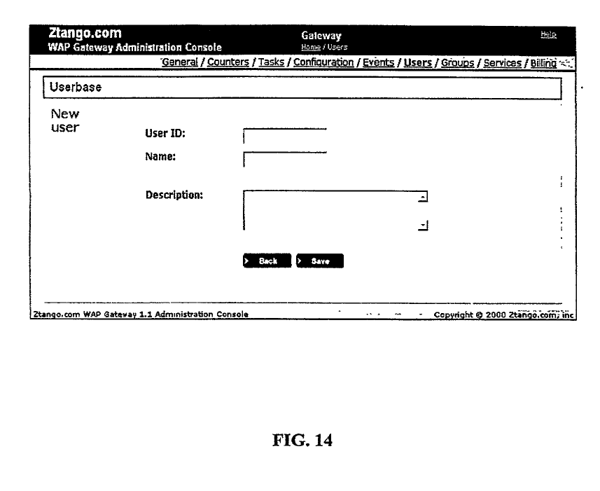

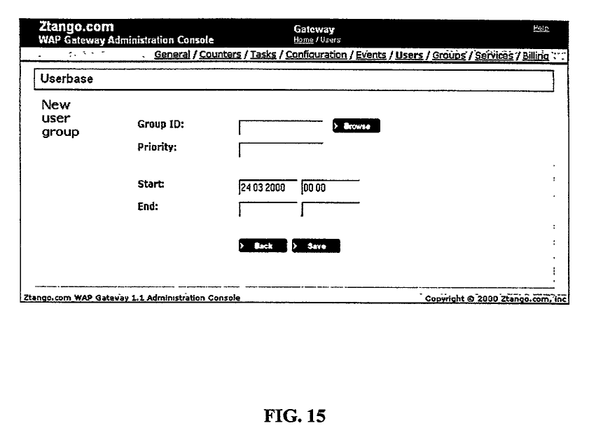

To add a user 8 or a group, go to an empty User FIG. 14 or Group page FIG. 15 and provide the WAP Gateway 2 with information about the user 8 or group. On the Users/Groups pages, click “New”. In the ID text box, provide an ID number for the user 8 or group. If you leave the box blank, the Knowledge Base 12 will automatically assign an ID. After you have created the user 8 or group, the ID cannot be edited. In the Name text box, enter the user's 8 or group's name. In the Description text box, enter freeform notes about the user 8 or group (optional). Click “Save”. Click “Ok”. Clicking “Back” twice at this point takes you back to the New User 8 page where you can continue to modify the user 8 account by clicking each link in turn: Bearer addresses, Subscriptions, Groups and Aliases. When you have provided the information required on each page, you can click “Back” again to return to the user's New User page FIG. 14.

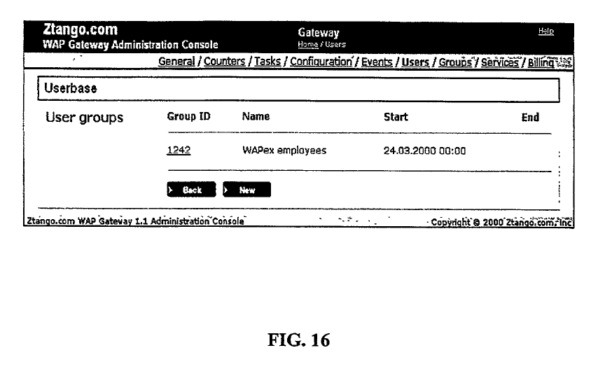

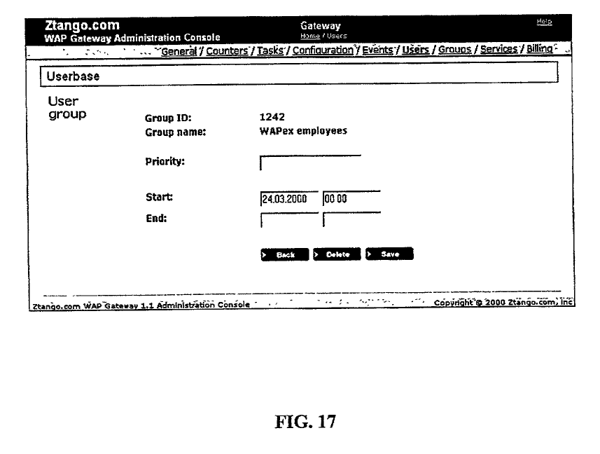

To view an existing group membership or edit the time frame, find the user 8 in the Knowledge Base 12. Click the Groups link. The user's User groups page FIG. 16 opens. In the link list, click a group ID. The User group page FIG. 17 opens.

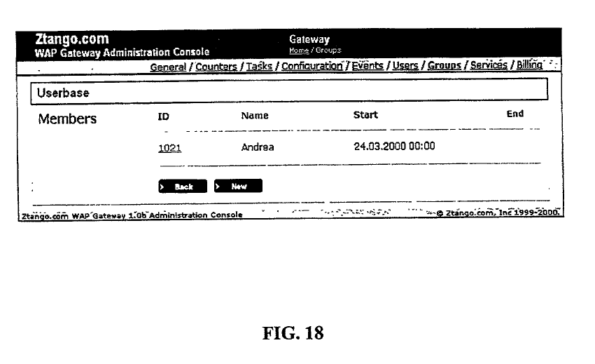

You can also view all the memberships attached to a specific group, and edit each individual membership through the group's pages. To add members to a group through the group's Members page FIG. 18, find the group in the Knowledge Base 12. Click “Members.” The group's Members page FIG. 18 opens. Click “New”. An empty Group member page opens. In the User 8 ID text box, enter the ID of the user 8 you want to add as a member. To find users 8 in the Knowledge Base 12, click “Browse.” In the Priority text box, enter a number from 1 to 999. In the Start text boxes, enter the date and the time when the membership becomes valid. In the End text boxes, enter the date and the time when the membership ceases to be valid. Click “Save”. Click “Ok”.

To view or edit a group's members, find the group in the Knowledge Base 12. Click the “Members” link. The group's Members page FIG. 18 opens, displaying a list of the group's members. To edit a member, click the member's ID in the list and modify the membership properties.

To add a user 8 to a group Find the user 8 in the Knowledge Base 12. Click “Groups.” The user's 8 Groups page FIG. 16 opens. Click “New”. The New user group page FIG. 15 opens. In the Group ID text box, enter the ID of the group you want to add the user 8 to. In the Priority text box, enter a numerical value from 1 to 999 that describes the priority of the membership. In the Start text boxes specify the date and the time when the group membership becomes valid. In the End text boxes, specify the date and the time when the group membership ceases to be valid. Click “Save”. Click “Ok”.

Use the Groups page search to locate the desired group and add the user 8 to the group's member list. Alternatively, go to the user's Groups page FIG. 16 and locate the desired group from there. On both the Users, FIG. 4, and the Groups pages, three text boxes are displayed:

Search bearer: Enter the user's 8 WAP terminal's bearer address (telephone number or IP address) to find the user 8 in the Knowledge Base 12;

Search name: Enter the user's 8 name to find the user 8 in the Knowledge Base 12; and

Search ID: Enter the user's 8 or group's unique identifier to find the user 8 in the Knowledge Base 12.

To find a user 8 or a group in the Knowledge Base 12 enter the user 8's or group's (if an organization) bearer network address in the Search bearer text box on the Users/Groups page. The format for GSM numbers (MSISDN) is the international format without spaces (+nnnnnnnnnnnnnnn=15 characters); the format for IP addresses is the standard n.n.n.n format. Another alternative is to enter the user's 8 or group's name either in its entirety (Susan User) or with wildcards (Susan Us*) in the Search name text box on the Users/Groups page. A yet further alternative is to enter the user's 8 or group's unique identifier in the Search ID text box on the Users/Groups page. Next to the text box you edited, click “Search.” A list of the users/groups that match the query is displayed. Click the ID of the user/group in the list to view the user's/group's information. The user's User page or the group's Group page is displayed.

A user 8 may have several group memberships that provide the same service. By specifying a priority for each membership it is possible to arrange them so that the membership with the highest priority is applied when the user 8 connects to a service: 1 is the highest priority, 999 the lowest.

Also specify a time frame for the membership. You must enter at least the start date. If you do not enter an end date, the membership is permanent.

There are two ways you can deny a user 8 Gateway 2 access:

Disable authentication for the user's 8 bearer addresses

Delete the user's 8 account

Both methods result in the user 8 being logged on as an anonymous user when connecting to the Gateway 2.

You can make authentication fail in two ways:

Set the user's 8 bearer address to expire

Disable authentication for the user's 8 bearer address

When the user's 8 bearer address expires, authentication is no longer allowed for that address. You can set the expiration time to the current date and time to force the address to expire immediately. The same effect is achieved by disabling authentication directly. As a result the address entry might as well not exist in the Knowledge Base 12.

You can delete users 8 only after you have withdrawn their subscriptions and group memberships. To delete a user 8, first manually unsubscribe the user 8 from services and remove the user 8 from all groups.

When a caller connects to the Gateway 2, the caller is authenticated by matching the address of the caller's device with the addresses stored in the Knowledge Base 12. If authentication succeeds, the user 8 ID that is associated with the address is taken into use. Authentication can fail for several reasons:

The user 8 does not have an account

Authentication is disabled for the caller's bearer address

The connection fails

The Knowledge Base 12 is offline or otherwise inaccessible

The radius address resolver does not identify the bearer address

Users 8 whose call cannot be authenticated are logged on as anonymous users with a special anonymous-ID. Just like the IDs of individual users 8, the anonymous-ID can be granted certain service accesses and denied others. Use the anonymous-user account to specify services that you want users 8 to be able to access even if authentication fails.

Instead of entering the information for each user 8 individually in the Administration Console FIG. 5, it is possible to import user 8 information into the Knowledge Base 12. Compile user 8 information in a text file, for example, and import it into the Knowledge Base 12. You can also utilize existing information if it is the right format.

Groups in the Knowledge Base 12 are logical entities. They can be formed on any basis, and group members do not need to have anything in common except the group membership. Of course it makes sense to create groups whose members share some characteristic, even if it is only one service subscription; otherwise why create the group at all?

Groups are defined as users 8 of a particular kind. The difference lies in the properties that are attached to groups as opposed to individual user 8 properties.

You can choose between two kinds of groups: organizations and ordinary groups. Service providers 6 are entered into the Knowledge Base 12 as organizations. Groups consist of individual users 8. Groups cannot belong to other groups.

A special user group is the one that consists of all users 8. Use the All Users group to specify settings that you want to apply to all those who access the Gateway 2.

To create groups, provide the following information:

Name

Unique identifier

Members

Service subscriptions

Like individual users 8, each group needs a unique identifier. The members of the group are users 8 that you want a group of settings to apply to. For example, use groups to specify certain users 8 as recipients of a set of services that the group subscribes to. The unique identifier for group users 8 follows the same guidelines as the IDs for individual users 8. You can either specify an identifier from an outside system or let the Knowledge Base 12 assign one. The identifier cannot be edited afterwards. The group identifier can include up to 16 characters. Include only the following types of characters:

a-z

A-Z

0-9

The members of groups can only be individual users 8, not other groups. The individual-group hierarchy is limited to these two levels. You cannot include groups in other groups. You can also create a group with only a single user 8 as a member. Some subscriptions are associated with groups rather than individual users 8.

The Administration Console FIG. 5 allows you to specify groups as either ordinary groups or organizations. When you create a service provider 6 entry, specify the group as an organization. In other words, a service provider 6 must be an organization.

Apart from service providers 6, it is usually not important which type of group you specify in this version of the WAP Gateway 2. The two group types are currently handled in the same way, but in future versions of the Gateway 2 many of the functions associated with each may be differentiated. However, all current functionality will be fully preserved.

The main difference between the two is that while an ordinary group is a logical entity created for convenience in handling users 8 in the Gateway 2, an organization is an existing entity. For example, an organization can have one set of contact information while having a lot of users 8.

All Users is a special group that includes all those users 8 who access the WAP Gateway 2. You can subscribe the All Users group to services in the normal way. Use this group to specify services you want all users 8 to be able to access regardless of what groups they belong to. This way you avoid having to subscribe every group you create to such services. You can also use the All Users group to set global options like aliases.

The All Users group is provided by default and it cannot be deleted from the Knowledge Base 12. When a new user 8 is created, the user 8 is automatically added to the All Users group.

Edit the All Users group options as you would any other group's options starting from the Groups page of the Administration Console FIG. 5.

After you have created a group FIG. 15, you can modify its settings on the Edit Groups page FIG. 17 in the Administration Console FIG. 5.

Use the search to locate the group by its identifier or its name, then edit the fields on the Edit Group page, FIG. 17. You can for example edit the group's subscriptions, billing parameters, members and group-level aliases.

There are three ways to deactivate unnecessary groups:

Set the users' 8 group memberships to expire

Set the group's service subscriptions to expire

Delete the group

Users' 8 group memberships are time-limited, so setting them to expire removes the users 8 from the group. When the group has no members, it is no longer functional.

Another way to make a group nonfunctional is to remove the settings that are its reason for existing. The settings most crucial in this regard are the service subscriptions that group membership offers to users 8. All the other settings depend on the subscriptions.

You can edit the subscriptions so that they expire for the group that you want to make nonfunctional. When the group's subscriptions are no longer valid, the user 8 members cannot access the services through the group.

You can only delete groups without service subscriptions and members. To delete a group, first manually remove all users 8 from the member list and withdraw the group's service subscriptions. You can delete any group except the All Users group.

Aliases that you want to apply to all users 8 are best defined as aliases for the All Users group. Apart from this, two levels of customization are available:

User-specific aliases

Group-specific aliases

This is the hierarchy that the Gateway 2 software uses to resolve aliases. When resolving, the Gateway 2 first checks the user 8 aliases, and then the group aliases. User-specific aliases are customizations by individual users 8. For example, users 8 may modify their homepages. The group-specific aliases are customizations meant to apply to entire groups of users 8. For example, if you have a group of users 8 called WAPex employees who all receive their Gateway 2 access through their employer WAPex, you can define the WAPex homepage as the default homepage for all members of the WAPex employees group. Note that because user 8 aliases are resolved before group aliases, the WAPex employees can still define their own homepages if they choose to.

Users 8 and groups can have specific aliases only for their use. To edit user 8 or group level aliases, Find the user 8 or group in the Knowledge Base 12. Click the “Aliases” link. The user's 8 or group's Aliases page FIG. 13 opens. Click an existing alias in the link list. Alternatively, click “New”. The User 8 alias page FIG. 13 opens. In the Name text box, enter a name for the alias. In the URL text box, enter the URLs for the alias. The URL is case-sensitive. A yet further alternative is to click “Browse” to search for the URL in the list of URLs already added to the Gateway 2. Click “Save”. Click “Ok”. Define aliases on the users' or groups' Aliases page FIG. 13 in the Administration Console FIG. 5. Note that the URLs are case-sensitive.

By default, users' 8 service access always requires a subscription, no matter whether the service is free of charge or if access is invoiceable. Users' 8 access to services is determined in one of two ways:

By subscribing users 8 directly to services.

By subscribing entire groups to services and then defining individual users 8 as members of those groups.

Subscribing through groups is easier than creating a separate subscription for each user 8. For example, you can create a group “the users of service X” and then “subscribe” individual users 8 to service X by adding them to the group, without having to set billing options etc. separately for each user 8. On the other hand, subscribing individual users 8 separately offers more flexibility.

If an individual user 8 has access to a service through several subscriptions, the Gateway 2 has a hierarchy for determining which group's parameters it uses for the connection. When service access is being determined, the Gateway 2 first searches for subscriptions associated with the user 8 ID. If none are found, it checks the group ID. If even now no subscription is found, the All Users group is checked. In practice this means that the subscription settings associated with the user 8 ID and set individually for each user 8 “outrank” the settings associated with the group ID.

Use the Subscriptions page FIG. 10 in the Administration Console FIG. 5 to subscribe both individual users 8 and groups to desired services. The following information must be provided:

Service name

Service ID

Start and end dates

Payer

Access level control

Billing options

Service ID is the service's unique identifier.

The start and end dates and times specify the time period during which the subscription is valid. Enter dates and times in the format dd.mm.yyyy and hh:mm. If you do not specify an end date, the subscription is permanent until the service itself expires. The time period must fall within the time frame during which the service itself is valid. If nothing prevents the end date from not being defined, it is recommended that you leave the field blank, because the service's end date is edited independently. If the subscription end date is blank, the two fields cannot come into conflict.

Billing model refers to the billing model that is applied for invoicing the user 8 for services that the user 8 subscribes to. When defining this option, only those billing models that have been defined for the service in question are available.

The payer refers to the person or entity who pays for the individual user's 8 or the group's service access and use. For example, this may be the company who employs the individual user 8. Use the Users or Groups page in the Administration Console FIG. 5 to set a payer.

You do not have to set access levels for all service subscriptions. If the service does not utilize the access level functionality, all subscribers automatically have access to all URLs defined for the service.

Billing options are set either at the group level or through individual services, depending on the option in question. The billing options you can set are:

Free access or paid access

Payment based on the number of transactions executed or a fixed time frame during which the service is available

Invoice included in phone bill or paid in advance.

All the services you subscribe a group to will be accessible to the group's members. You can subscribe a group to as many services as you like. An individual user 8 can have access to a specific service through several groups or individually. In such cases the Gateway 2 hierarchy determines which settings are used.

Often service subscriptions are associated directly with the user 8 instead of with a group. This is particularly the case when the user 8 needs a subscription that somehow differs from what most other users 8 require. When you set individual subscription parameters, there are more combinations available for customizing service access and pricing.

A single service can provide several levels of content so that different users 8 have different levels of access. For example, all users 8 may have access to a service's homepage; for those who pay an extra fee, access to some additional URLs may be granted. The access levels associated with each URL of a service are hard-coded into the service itself. Define an access level for each user 8 on the page you use to edit a particular user's 8 specific subscription. The drop-down list gives you a choice from the levels that are in use for each service.

Accordingly, it will be understood that the preferred embodiment of the present invention has been disclosed by way of example and that other modifications and alterations may occur to those skilled in the art without departing from the scope and spirit of the appended claims.

What is claimed is:

1. A method for managing users and services in a system for providing information over a Wireless Application Protocol Gateway, comprising:
creating a service provider entry for a company that provides a service;
adding said service as available to users;
creating a user account for a specific user on a database; and,
creating a subscription to at least one available service for said user.

2. A method as in claim 1, wherein said method further comprises assigning said user to at least one available group of users.

3. A method as in claim 2, wherein said group of users is subscribed to at least one available service.

4. A method as in claim 1, wherein creating a user account further comprises assigning said user a unique identification for utilization by said system.

5. A method as in claim 1, further comprising deleting said user from said database.

6. A method as in claim 1, further comprising disabling authentication for said user's bearer address.

7. A method as in claim 6, wherein disabling can be achieved by setting said user's bearer address to expire at a certain date and time or by directly disabling the ability of said bearer address to be authenticated.

8. A method as in claim 5, wherein deleting occurs after all user subscriptions and group memberships have been withdrawn.

9. A method as in claim 1, wherein said system assigns an anonymous status to users who cannot be identified.

10. A method as in claim 2, wherein said groups are assigned a unique identification for utilization by said system.

11. A user interface for administration and management of users and services in a Wireless Application Protocol Gateway on a graphical display surface, comprising:
a series of screens, modifyable by a system, that allow said administrator to create and maintain user and group accounts, authenticate user identities for the purpose of assigning an access level and granting the use of services, assign service subscriptions to a specific user or group, set parameters on the length of time a specific user or group has access to services, define payers and payment methods for each service subscription that a user or a group has, define user and group aliases for customized identification, import or export user and group information in a usable format.

12. A user interface of claim 11, wherein customer service personnel are capable of modifying said screens.
